(19) United States
(12) Patent Application Publication
(10) Pub. No.: US 2010/0168897 A1
(43) Pub. Date: Jul. 1, 2010

(54) Control Component and Method for an Energy Management Unit in an Industrial Automation Arrangement

(75) Inventors: Joachim August, Nurnberg (DE); Norbert Brousek, Furth (DE); Oliver Jöhssen, Erlangen (DE); Joachim Ohlmann, Herzogenaurach (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/625,039

(22) Filed: Nov. 24, 2009

(30) Foreign Application Priority Data
Nov. 28, 2008 (EP) 08 020 699

(51) Int. Cl. G06F 19/00

(52) U.S. Cl. 700/105; 700/111

(57) ABSTRACT

A control component and method for an energy management unit (EM) in an industrial automation arrangement which is configured to control one of a process, a subprocess and a system part of the industrial automation arrangement. Here, the control component is configured to detect the energy consumption of at least one part of the industrial automation arrangement, and the control component is configured to relate the detected energy consumption to at least one stored specification. The control component is also configured to generate a request for at least one automation component as the result of the relating operation. The control component is configured to transmit a message containing the request to the automation component and to receive an acknowledgement message from this automation component, where the request is directed to changing an operational state of one of the process, subprocess and system part that is controlled by the automation component.

### BACKGROUND OF THE INVENTION

1. Field of the Invention

The invention relates to control systems and, more particularly, to a method and control component for an energy management unit in an industrial automation arrangement.

2. Description of the Related Art

Usually, industrial automation arrangements (also called programmable logic controllers (PLC)) comprise a multiplicity of automation components that are connected to one another by a data network, such as a field bus system. The automation components comprise, for example, sensors and actuators, where the actuators mentioned are particularly used to control industrial processes, subprocesses of industrial processes, production systems or the like. The automation components also include control devices, such as CPUs and controllers, which are used to process the signals detected by the sensors in a program-controlled manner, and to control a production system or another process or subprocess by driving the actuators. In addition, central components of an industrial automation arrangement are, for example, super-ordinate controllers, such as Manufacturing Execution Systems (MES), central power supplies and energy management systems (Totally Integrated Power (TIP)), observation and operating workstations, databases, communication means and gateways.

A central task when controlling industrial production or an industrial process is to handle the available resources as economically as possible, in particular to minimize the consumption of (usually electrical) energy. It is therefore possible, for example, to switch off system parts that are temporarily not required, by using the corresponding automation components, or to change the system parts to a standby mode. This may be performed, for example, manually or in a time-controlled manner in operational pauses, at night or on Sundays/holidays.

In addition to the requirement to reduce the total energy consumption of an automation arrangement, such as by implementing energy-saving measures, it is desirable to reduce the so-called peak load, i.e., the maximum energy consumption in an observed time period. The reason for this, inter alia, is that the tariff models of energy suppliers in the industrial sector calculate higher tariffs for the electrical energy that is used at peak load than for a “base load” which remains the same. In addition, the technical devices used to distribute and supply energy have to be operated within their operating limits, with the result that peak loads that exceed these operating limits must be avoided. In industrial automation arrangements when a peak load situation arises, it is therefore customary to temporarily switch off those automation components and, thus, those “loads” in which temporary switching-off does not have a negative influence on industrial production, the industrial production process or the like, or at least does not constitute a safety risk.

The foregoing strategy is also referred to as “peak-load-controlled load shedding”. For example, electrical heating systems that are intended to maintain a medium at a particular temperature in a storage container can be switched off, as long as the temperature of the medium does not fall to or below a minimum value. In another example, pumps that are used to fill storage containers can be temporarily switched off or their delivery rate can be reduced, as long as the filling level of the storage container does not fall to or below a minimum value. A corresponding situation applies to wastewater pumps.

In each of the above examples, the automation components and the devices controlled by the latter are temporarily switched off or “stepped down”, either manually or in an automated manner by a control device. A disadvantage with manual control is that the person performing the control operation must have accurate knowledge of the operating limits, such as minimum filling levels and minimum temperatures, the current operational state, such as filling level, temperature, and the possible operational states (i.e., on, off, standby, partial load, full load), and the associated energy consumption of the individual automation components. Moreover, the operator must relate these details to a status of the entire automation arrangement, usually the current total energy consumption, and associated operating limits, such as peak load allowed, which imposes a high demand on the knowledge of the process to be controlled overall and of the individual subprocesses and the associated automation components.

Similar demands are also imposed on automatic control, which likewise must take into account both the states and operating limits of the individual automation components, as well as the states and operating limits of the entire process to be controlled and, thus, the entire industrial automation arrangement. Accordingly, there is a high degree of complexity of the control task and an undesirable error rate occurs due to the complexity of the process knowledge and because individual automation components and individual subprocesses are often changed.

### SUMMARY OF THE INVENTION

It is therefore an object of the present invention to simplify energy management for industrial automation arrangements and, in the case of changed automation components and subprocesses, to reliably take these changes into account.

This and other objects and advantages are achieved in accordance with the disclosed invention by holding (i.e., “encapsulating”) the production-related knowledge of the processes/subprocesses or system parts in a respective controlling automation component, and by providing a control component that is configured to retrieve this production-related knowledge from one or more of the automation components. As a result, it is possible to manage the energy for the industrial automation arrangement by “negotiating” changed operational states for the processes/subprocesses or system parts.

In accordance with the invention, a control component is provided for an energy management unit in an industrial automation arrangement, where the control component and at least one automation component to be controlled in the automation arrangement is networked via communication means, and the automation component is configured to control a process, a subprocess or a system part of the automation arrangement. Here, the control component is configured to detect the energy consumption of at least one part of the automation arrangement and is configured to relate the detected energy consumption to at least one stored specification. The control component is also configured to generate a request for the at least one automation component as a result of the relating operation, where the control component is also configured to transmit a message containing this request to the at least one automation component and to receive an acknowledgement message from this automation component. Here, the request relates to changing an operational state of the process, subprocess or system part that is controlled by the automation component, where a change of the operational state is also associated with a change in the energy consumption of the process, the subprocess or the system part.

The disclosed control component can be used to induce the change of an operational state of at least one part of the automation arrangement, but a decision regarding the actual change of the operational state can be made in the corresponding automation component. As a result, the conformity of the change of the operational state to a current state of a production process or subprocess can be checked in a decentralized manner. Moreover, a reliable method of operation of the automation arrangement is provided when the control component contains only a few or insufficient items of state information relating to the individual processes, subprocesses or system parts.

The object of the invention is achieved by a method for operating a control component for the energy management unit in an industrial automation arrangement having at least one automation component. At least two operational states of a process, subprocess or system part are controlled by the automation component, which operational states can be changed over and have differing levels of energy consumption. The automation component and the process, subprocess or system part are arranged in the automation arrangement. In accordance with the disclosed method, in a first step, the control component directly or indirectly detects the energy consumption of at least one part of the automation arrangement. In a second step, the control component relates the detected energy consumption to a desired value or a limit value. In a third step, the control component uses the relating operation to generate a request message containing a request to change the process, the subprocess or the system part to an operational state with an energy consumption that differs from the actual state and sends the message to the automation component. In a fourth step, the control component receives an acknowledgement message from the automation component, where the acknowledgement message includes at least one statement relating to whether the operational state can be changed, as required using the request message. Finally, in a fifth step, the automation component changes the operational state for the controlled process, subprocess or system part. The disclosed method makes it possible to manage the energy for at least one part of the industrial automation arrangement by interchanging information between the control component and an automation component, where the automation component is able to check the specifications made by the control component with regard to their current practicability.

The control component is also advantageously configured to receive and process a status message from the automation component, where the status message comprises information relating to the respective (e.g., current) operational state and/or the respective (e.g., current) energy consumption of the automation component. This value may either specify the consumed power in absolute terms or may be a relative statement of a nominal power. As a result, it is possible for the control component to compare the current operational state with pre-stored information relating to the possible operational states, with the result that the transmission of request messages that cannot be implemented or unnecessary request messages can be avoided. For this purpose, it is also advantageous if this status message or another status message includes at least one statement relating to a plurality or all of the operational states which can be changed over by the automation component for the process, subprocess or system part. Such a status message can advantageously be retrieved by the control component sending a special interrogation message to the respective automation component for this purpose. In this case, even better plannability results if the status message includes, at least for one of the operational states which can be changed over, a statement relating to the period of time respectively needed for the changeover operation. Plannability is improved further if the status message alternatively or additionally includes, for at least one of the operational states which can be changed over, a statement relating to the maximum possible duration of this operational state to be changed over.

The control component and the method which can be performed with the latter can be implemented in existing automation arrangements in a particularly simple manner if the control component is in the form of software or a software plug-in of an energy management system or an energy supply device.

In this case, it is possible to use an existing infrastructure without the need to purchase new hardware if the control component is set up to use a data transmission system which is present anyway, for example a field bus system, as the communication means.

The method and the control component are used in a simple manner with automation components from different manufacturers if the control component is set up to manage standardized operational states for the automation components and the processes, subprocesses or system parts controlled with the latter. As a result, it becomes possible to simplify the communication protocol between the control component and the automation components to be controlled in a manner such that short and clear commands and messages occur. As a result, the additional volume of data becomes minimized. The standardized operational states advantageously include at least full load operation, partial load operation, a pause operational state and/or a mode for a time-limited maximum energy saving. The most important operational states can therefore be covered by simple messages.

In order to manage the energy as comprehensively as possible, the control component is advantageously configured to operate in an automation arrangement having a plurality of automation components and accordingly a plurality of processes, subprocesses or system parts, where the control component is configured to transmit a message containing a request to a plurality of automation components or to each automation component in an order that is defined using a prioritization table or a prioritization rule. The practice of heeding such a table or rule makes it possible to implement different strategies, for example, predominantly non-critical processes are included in energy management, or processes or system parts with fast reaction times are preferably controlled. In this case, the control component can be flexibly adapted to the respective state of the production process or the like if the relating operation is performed after a plurality or all of the acknowledgement messages have been received and taken into account.

An improvement in the control strategy presupposes that it is possible to learn from previous control actions. For this purpose, the control component is advantageously configured to document the messages containing the requests, which have been transmitted by the control component, and to document the received acknowledgement messages and/or the received status messages.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the control component according to the invention are explained below using the drawings. They are simultaneously used to explain a method according to the invention, in which:

FIG. 1 is a schematic block diagram of an automation arrangement having an energy supply, an energy management unit, a planning entity and subprocesses;

FIG. 2 is a schematic block diagram of an exemplary structure of messages with requests, acknowledgement messages and status messages;

FIG. 3 is an exemplary explanation of different bits (“flags”) in the messages of FIG. 2;

FIG. 4 shows a planning table of the planning entity of FIG. 1; and

FIG. 5 is a flow chart of the method in accordance with the invention.

### DETAILED DESCRIPTION OF THE PRESENTLY PREFERRED EMBODIMENTS

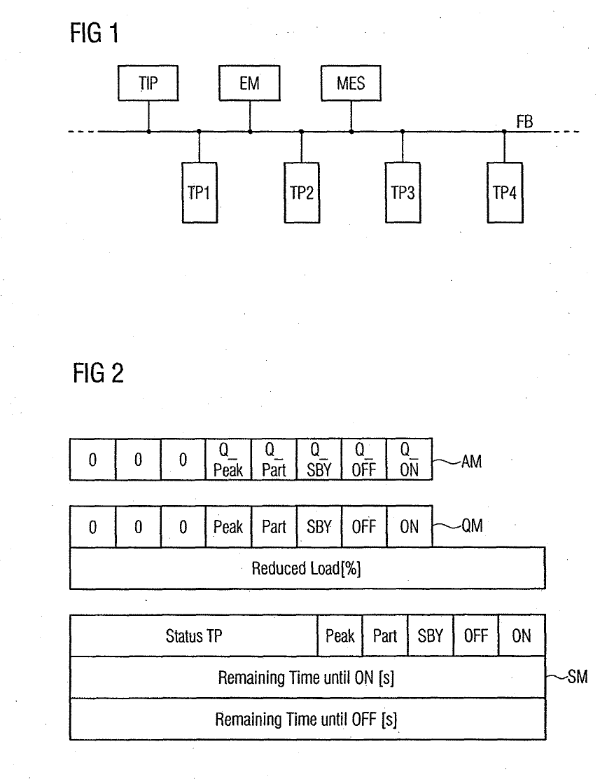

FIG. 1 shows a schematic block diagram of an industrial automation arrangement, such as a production system, in which automation components (TP1, . . . , TP4) (subprocesses) are arranged via a data network field bus system (FB), the automation components (TP1, . . . , TP4) each representing a subprocess to be controlled. Consequently, a respective subprocess is controlled by a respective automation component (TP1, . . . , TP4). In addition, the energy supply (Totally Integrated Power (TIP)), an energy management device (EM) with a control component and a planning entity (Manufacturing Execution System (MES)) are integrated in the automation arrangement using the data network (FB) and using an infrastructure (for example, energy supply lines) which is not illustrated for purposes of clarity.

The control component is configured for message-based interchange of control and state data relating to the settings of an energy-saving profile integrated in each of the automation components (TP1, . . . , TP4). This energy-saving profile comprises a set of different and, preferably, standardized operating states, where the standardization in the present exemplary embodiment relates to the operating states themselves, and to the message-based or register-based control related to the operating states. In the present exemplary embodiment, the control component is integrated in the energy management device (EM) as a software plug-in. As an alternative, the control component may comprise an independent device or may be integrated as software or a software plug-in inside other components, in particular in the energy supply (TIP) or in the planning entity (MES). However, the control component may also be configured, in particular, such that it manages the energy for the automation arrangement; in this case, the terms “control component” and “energy management” would be synonymous.

As discussed below, it shall be assumed, by way of example, that the automation component (TP1) controls, as a subprocess, a compressor which fills a compressed air storage container which is important for the production system. Here, the intention is to use the control properties of the automation component (TP1) to maintain the pressure of this storage container between a minimum value and a maximum value. For this purpose, the rotational speed of the compressor can be controlled. As a result, its pumping capacity and, thus, its energy consumption (consumption of electrical power from the energy supply (TIP)) can also be continuously controlled.

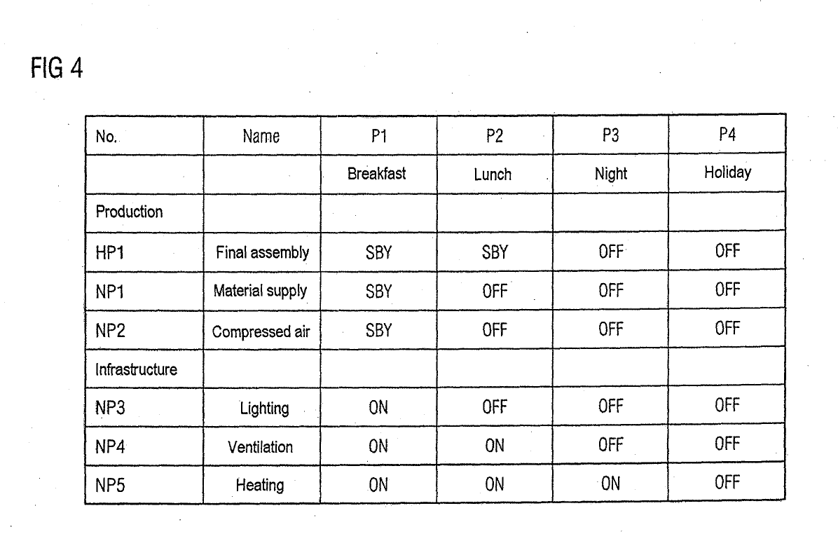

The energy supply (TIP) continuously monitors the electrical power consumed by the entire production system, and continuously provides the energy management unit (EM) and, thus, the control component with this value via the data network (FB). Furthermore, the planning entity (MES) supplies the energy management unit (EM) with planning data relating to production of the production system likewise via the data network (FB); such planning data are illustrated by way of example in FIG. 4.

Alternatively, it is also possible to consider the energy consumption of fewer subprocesses or else of only a single subprocess; this presupposes the existence of appropriately differentiated measuring devices. In a further, alternative exemplary embodiment, the current, the minimum and/or the maximum energy consumption of a subprocess or system part can also be read from the corresponding automation component (TP1, . . . , TP4) using interrogation messages; this makes it possible to save measuring means.

The control component of the energy management unit (EM) is configured such that, in cases in which the electrical power consumed by the production system or the partial production system in question approaches or exceeds a first limit value, the power of those processes and subprocesses which do not have to be continuously operated with a uniform load is intended to be stepped down. This is the case with the compressor which is controlled by the automation component (TP1). If the pressure in its storage container is above the minimum pressure, the delivery rate of the compressor and, thus, its energy consumption can be reduced or even switched off entirely. In order to achieve this, the control component communicates with the automation component (TP1) using a standardized protocol. For this purpose, the energy management unit (EM) sends a standardized message, i.e., the request message (AM), to the automation component (TP1).

FIG. 2 is a schematic block diagram of an exemplary structure of the request messages (AM), the acknowledgement messages (QM) and the status messages (SM). In simplest form, the payload of the request message (AM) comprises only one byte in which the bit with the designation “Q_Part” is intended to cause the automation component (TP1) or the subprocess controlled by the automation component (TP1) to be changed to an operating state which corresponds to partial load operation (“Part”). In an embodiment, the request message (AM) may also comprise two further bytes (not illustrated) which specify a percentage value for the desired load reduction; it is alternatively also possible to work with absolute values or power classes/power levels. The automation component (TP1) responds with an acknowledgement message (QM) which is likewise diagrammatically illustrated in FIG. 2, and preferably provides information relating to the implementation or non-implementation of the request message (AM) likewise by setting individual bits in a standardized manner. In accordance with the presently contemplated embodiment, the fourth bit “Part” is set in this acknowledgement message (QM). As a result, the automation component (TP1) confirms the changeover to partial load operation of the compressor. In two further bytes, the acknowledgement messages (QM) also provide information relating to the percentage by which the consumed power could be reduced, for example, 50%. Furthermore, temporal statements relating to the changeover can be made using the acknowledgement message (QM) or, like here, by using a separate status message (SM). The period of time until the changeover (“remaining time until on”) is thus set to zero in the present case because the changeover has already occurred. The relapse time (“remaining time until off”) is that amount of time which is predicted by the automation component (TP1) and will elapse before the operational state is changed again (here: to full load operation). For this purpose, the automation component (TP1) not only checks, before the changeover to partial load operation, whether the pressure of the pressure vessel is above the minimum limit but also takes into account the pressure gradient (e.g., the pressure drop per unit time) to calculate when the minimum pressure will be reached with the current reduced delivery rate of the compressor. These measures prevent the reduction in the energy consumption of the subprocess, as required by the energy management unit (EM), resulting in an unwanted state (here: reduced pressure).

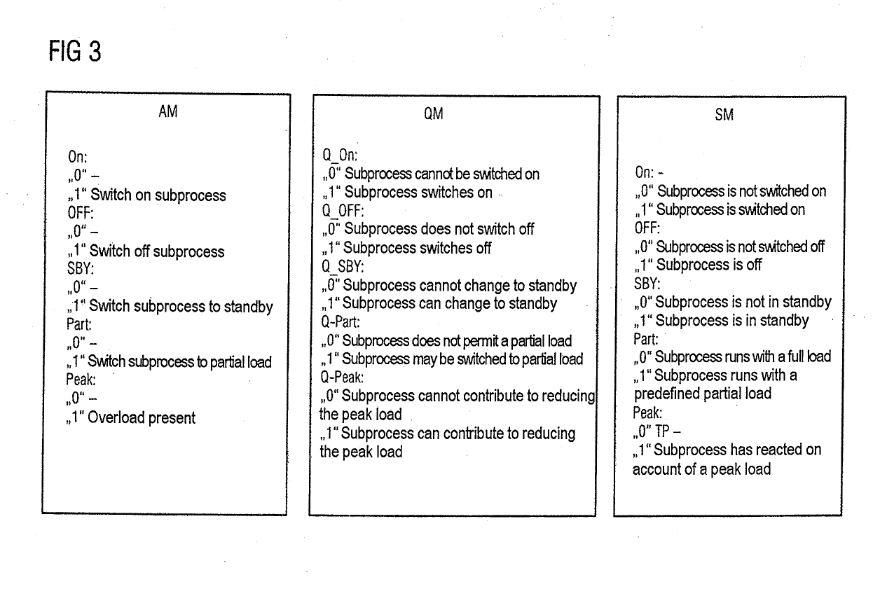

FIG. 3 is an exemplary explanation of different bits (“flags”) in the messages of FIG. 2. That is FIG. 3 is a table providing the meanings of the individual bits in the messages. It should be understood that other conventions relating to the interchange of messages, i.e., text-based or variable-based instructions, may also be agreed. In particular, information need not be transported between the control component and, thus, the energy management unit (EM) and the automation components (TP1, . . . , TP4) using messages at all but, rather, the corresponding data words (bytes) may also be stored in a common database or in another information memory in a manner such that they can each be accessed or at least read. This applies, in particular, to so-called “global variables” of the production process.

Instead of the above-described percentage load specifications, it is also possible to use absolute values, for example, in the unit “kilowatts”, in particular for the electrical power saved.

FIG. 4 shows a planning table of the planning entity of FIG. 1. That is, FIG. 4 illustrates, by way of example, product planning of the planning entity (MES) in the form of a table. Such planning data are advantageously used by the control component of the energy management unit (EM) to perform prioritization when transmitting request messages (AM). That is, not only are the rigid specifications from these tables (for example, the switching-off of lighting in operational pauses) implemented using the request message (AM) sent by the energy management unit (EM) but also such processes like the exemplary pressure accumulator are changed over to the “full load” operational state, for example, in operational pauses in which the total consumption of electrical power is already low, in order to again be ready with a maximum supply of compressed air following the operational pause in order to relieve the load on the energy supply (TIP). The energy management unit (EM) can control a multiplicity of automation components (TP1, . . . , TP4) and the associated subprocesses. Consequently, the energy management unit (EM) can accurately and globally negotiate the saving in the necessary energy consumption or can contribute to temporally leveling out the energy consumption. The “overload” (“e.g., peak”) operational state in which the respective automation component is requested to immediately “shed” a maximum load contributes to this, in particular. In the case of this exemplary compressor, this means that the latter is switched off completely until a minimum pressure has been reached.

The automation component (TP1, . . . , TP4) is advantageously configured to transmit a list (not shown) containing all available operational states (e.g., on, off, standby, partial load or full load) using a special status message (SM), where this list optionally comprises statements regarding an average reaction time needed to switch on the respective operational state. In particular, devices which have been recently integrated in the production system can thus be automatically taken into account by the energy management unit (EM) and thus by the control component. Status messages (SM) can be transmitted either on request or automatically by the respective automation component (TP1, . . . , TP4). Automatic transmission is performed, in particular, when an operational state of the respective automation component (TP1, . . . , TP4) has changed. Here, it is also possible to set automatic transmission in defined intervals of time.

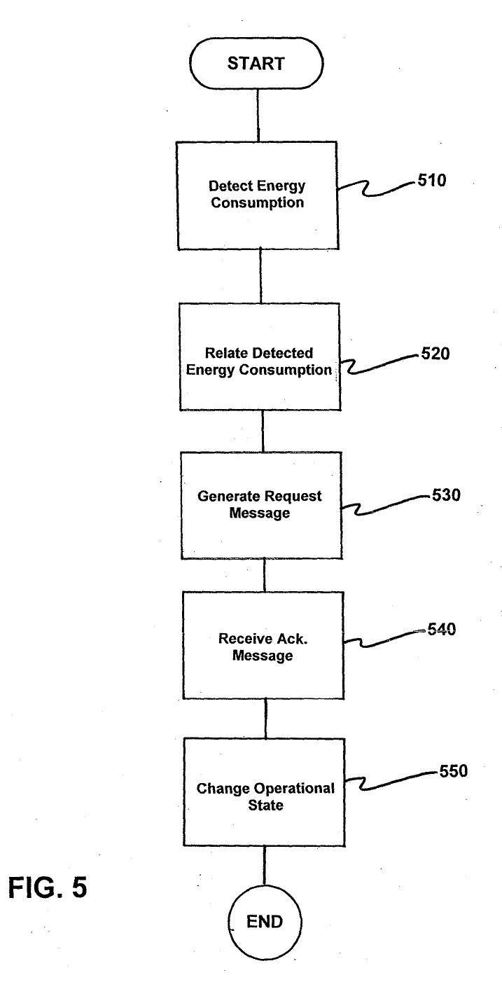

FIG. 5 is a flow chart illustrating the method in accordance with the invention. In accordance with the invention, the method operates a control component for the energy management unit in an industrial automation arrangement having at least one automation component with at least two operational states of a process, subprocess or system part controlled by the at least one automation component, where operational states are changed over and have differing levels of energy consumption and are arranged in the automation arrangement.

As shown in FIG. 5, energy consumption of at least one part of the automation arrangement is detected directly or indirectly at the control component, as indicted in step 510. Next, the detected energy consumption is related to a desired value or a limit value at the control component, as indicated in step 520.

A request message containing a request based on the relating operation is generated at the control component to change the operational state of one of the process, the subprocess and the system part, as indicated in step 530. Here, the control component sends the request message to the automation component.

An acknowledgement message is received from the automation component, as indicated in step 540. In this case, the acknowledgement message includes at least one statement relating to whether the operational state of one of the process, the subprocess and the system part can be changed as required using the request message. Next, the operational state of one of the process, the subprocess and the system part is changed at the at the automation component, as indicated in step 550.

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A control component for an energy management unit in an industrial automation arrangement, the control component and at least one automation component being controlled in the industrial automation arrangement and networked via communication means, and the automation component being configured to control one of a process, a subprocess or a system part of the industrial automation arrangement;
wherein the control component is configured to detect the energy consumption of at least one part of the automation arrangement;
wherein the control component is configured to relate the detected energy consumption to at least one stored specification;
wherein the control component is configured to generate a request for at least one automation component as the result of the relating operation;
wherein the control component is configured to transmit a message containing the request to the at least one automation component and to receive an acknowledgement message from this automation component; and
wherein the request is provided to change an operational state of one of the process, subprocess or system part controlled by the automation component.

2. The control component as claimed in claim 1, wherein that the control component is configured to receive and process a status message from the automation component, the status message comprising information relating to at least one of an operational state and a respective energy consumption of the automation component.

3. The control component as claimed in claim 1, wherein the control component comprises one of software or a software plug-in module of an energy management system and an energy supply device in the automation arrangement.

4. The control component as claimed in claim 1, wherein that the control component is configured to use a field bus system as the communication means.

5. The control component as claimed in claim 1, wherein the control component is configured to manage standardized operational states for the automation component.

6. The control component as claimed in claim 5, wherein that the standardized operational states include at least one of full load operation, partial load operation, a pause operational state and a mode for a time-limited maximum energy saving.

7. The control component as claimed in claim 1, wherein the control component is configured for operation in an automation arrangement having a plurality of automation components to control a plurality of processes, subprocesses or system parts, the control component being configured to transmit a message containing a request for a respective automation component to at least two of the automation components in an order defined using a prioritization table or in an order defined using a prioritization rule.

8. The control component as claimed in claim 7, wherein the relating operation is carried out after a plurality of or all of the respective acknowledgement messages have been received and while simultaneously taking into account this plurality of or all of the acknowledgement messages.

9. The control component as claimed in claim 1, wherein the control component is configured to document messages containing requests transmitted by the control component, and to document at least one of received acknowledgement messages and received status messages.

10. The control component as claimed in claim 9, wherein a status message includes at least one statement relating to a plurality or all operational states which are changeable by the automation component for the process, subprocess or system part.

11. The control component as claimed in claim 10, wherein the control component is configured to retrieve the status message containing the at least one statement relating to each of said plural operational states or all operational states which are changeable using an interrogation message configured to perform operational state changes.

12. The control component as claimed in claim 10, wherein the status message includes at least, for one of the operational states which is changeable, a statement relating to a period of time needed for a changeover operation.

13. The control component as claimed in claim 11, wherein the status message includes, for at least one of the operational states which is changeable, a statement relating to a period of time needed for a changeover operation.

14. The control component as claimed in claim 10, wherein the status message includes, for at least one of the operational states which is changeable, a statement relating to a maximum possible duration of this operational state.

15. The control component as claimed in claim 11, wherein the status message includes, for at least one of the operational states which is changeable, a statement relating to a maximum possible duration of this operational state.

16. The control component as claimed in claim 12, wherein the status message includes, for at least one of the operational states which is changeable, a statement relating to a maximum possible duration of this operational state.

17. A method for operating a control component for the energy management unit in an industrial automation arrangement having at least one automation component with at least two operational states of a process, subprocess or system part of the industrial automation arrangement being controlled by the at least one automation component, the operational states being selectively changed over and having differing levels of energy consumption, the method comprising:
detecting, directly or indirectly at the control component, energy consumption of at least one of a process, subprocess or system part of the industrial automation arrangement;
relating, at the control component, the detected energy consumption to a desired value or a limit value;
generating, at the control component, a request message containing a request based on the relating to change the operational state of the one of the process, the subprocess and the system part, said control component sending the request message to the automation component;
receiving, at the control component, an acknowledgement message from the automation component, said acknowledgement message including at least one statement relating to whether the operational state of the one of the process, the subprocess and the system part can be changed as required using the request message; and
changing, at the automation component, the operational state of the one of the process, the subprocess and the system part.
